(19) United States
(12) Patent Application Publication
(10) Pub. No.: US 2010/0246078 A1
(43) Pub. Date: Sep. 30, 2010

(54) SEMICONDUCTOR INTEGRATED CIRCUIT DEVICE

(75) Inventors: Yoshiyuki UTAGAWA, Tachikawa (JP); Takeo Yamashita, Ome (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/685,009

(22) Filed: Jan. 11, 2010

(30) Foreign Application Priority Data
Mar. 30, 2009 (JP) 2009-080872

(51) Int. Cl. H02H 9/00

(52) U.S. Cl. 361/56

(57) ABSTRACT

A semiconductor integrated circuit device supports maintenance of a signal transfer frequency and waveform quality and electrostatic protection, and also suppresses expansion of a chip area. In order to maintain the signal transfer frequency and the waveform quality as well as to keep an effect of the electrostatic protection, and simultaneously to protect a differential input pair by a single electrostatic protection element and to attain area superiority, the electrostatic protection element that is arbitrarily separable is disposed at a middle point of a terminator.

### CLAIM OF PRIORITY

The present application claims priority from Japanese patent application JP 2009-080872 filed on Mar. 30, 2009, the content of which is hereby incorporated by reference into this application.

### FIELD OF THE INVENTION

The present invention relates to a signal transfer technology and a semiconductor integrated circuit implementing technology and, more specifically, to a technology of a method for disposing and separating an electrostatic protection element in differential high-speed terminals that are effective in applying it in a field that requires compatibility between electrostatic protection at the time of assembly and maintenance of a signal transfer frequency band and quality of a propagation waveform into the inside of a LSI at the time of actual use.

### BACKGROUND OF THE INVENTION

Conventionally, in order to realize compatibility between the electrostatic protection at the time of manufacture and the maintenance of the signal transfer frequency band and the waveform quality at the time of actual use, there is a semiconductor integrated circuit device of a configuration that separates an electrostatic protection element after the manufacture as one that is configured to make its electrostatic protection element arbitrarily separable (for example, refer to JP-A-2001-244338, JP-A-2007-073928, JP-A-Hei05 (1993)-121662, and JP-A-2004-128363).

### SUMMARY OF THE INVENTION

Prior to this application, the inventors of this application carryout an examination on compatibility between the electrostatic protection at the time of assembly and the maintenance of the signal transfer frequency band and the waveform quality at the time of being used as a differential high-speed input.

With speed enhancement of an operation frequency, a charging/discharging time of a wiring capacity between chips has become a level that cannot be disregarded to a signal cycle, and consequently attainment of lower signal amplitude is being performed in order to prevent deterioration of the waveform quality. However, although the attainment of lower signal amplitude gives advantages, such as charging/discharging time shortening of the wiring capacity between the chips, and attainment of lower electric power, it accompanies a drawback that an S/N ratio to a noise from the outside deteriorates. Then, in many of fast transfer methods, transfer by a differential signal that can remove an off-set by a noise component goes mainstream. FIG. 8 shows a schematic diagram in the case of using the related art technology in the above-mentioned field.

The related art method whereby a configuration of separating the electrostatic protection element after the assembly is installed for every terminal comes with a problem that the signal transfer frequency band and the waveform quality deteriorate due to effects of an increase of the discharging time and reflections caused by a remaining node after fuse blowout and a problem that an interface part becomes large because of installation of the fuse in every terminal, which leads to expansion of a chip area.

Along with the progress of a speed enhancement technology of LSI's, electrostatic countermeasures in production lines are also progressing, and in recent years ESD (Electrostatic Discharge) occurring at the time of manufacture is loosened (100 V or less, depending on a process control). From this fact, for further speed enhancement and miniaturization of the LSI, the inventors of this application have originally found a problem to be solved that it is necessary to make a circuit design by attaching importance to the maintenance of the signal transfer frequency band and the waveform quality and area reduction of the interface part, without taking an excess ESD countermeasure.

The above-mentioned JP-A-2001-244338, JP-A-2007-073928, JP-A-Hei05 (1993)-121662, and JP-A-2004-128363 each describe separation of the electrostatic protection element after the manufacture in order to reduce an input capacitance that becomes hindrance of the operation in the input terminals at the time of actual use, similarly with the present invention. Especially, JP-A-2001-244338 describes that a metal fuse or a silicon fuse is used as a mechanism of performing the separation.

FIG. 7 is a circuit configuration diagram that is a circuit diagram of the related art technology and is newly grasped from the inventors' original viewpoint.

JP-A-2001-244338 describes that the electrostatic protection element is separated after the manufacture. However, if this is used for a differential input interface, the remaining node after the fuse blowout will exist for every terminal for a signal input whose electric potential fluctuation at the time of actual use is large, as shown in FIG. 8, which will result in insufficient alleviation of a load at the time of operation. Moreover, as shown in FIG. 8, it is necessary to dispose a fuse to each terminal of the differential inputs, respectively, which becomes a factor to increase the area of the interface part.

Although JP-A-2007-073928 also describes that an electrostatic protection circuit is separated after the manufacture, if it is applied to the differential input interface similarly with JP-A-2001-244338, the remaining node after the fuse blowout will exist for every terminal for a signal input whose electric potential fluctuation at the time of actual use is large, as shown in FIG. 8, which will result in insufficient alleviation of a load at the time of operation. Moreover, as shown in FIG. 8, it is necessary to dispose the fuse to each terminal of the differential inputs, respectively, which becomes a factor that increases the area of the interface part.

Although also JP-A-Hei05(1993)-121662 describes that the electrostatic protection circuit is separated after the manufacture, if it is applied to the differential input interface similarly with JP-A-2001-244338 and JP-A-2007-073928, the remaining node after the fuse blowout will exist for every terminal for a signal input whose electric potential fluctuation at the time of actual use is large, as shown in FIG. 8, which will result in insufficient alleviation of a load at the time of operation. Moreover, as shown in FIG. 8, it is necessary to dispose the fuse to each terminal of the differential inputs, respectively, which becomes a factor that increases the area of the interface part.

JP-A-2004-128363 describes that the electrostatic protection circuit is separated in order to adjust an output load that is seen from the transmitting side device. If it is applied to the differential input interface, similarly with JP-A-2001-244338, JP-A-2007-073928, and JP-A-Hei05 (1993)-121662, the remaining node after the fuse blowout will exist for every terminal for a signal input whose electric potential fluctuation at the time of actual use is large, as shown in FIG. 8, which will result in insufficient alleviation of a load at the time of operation. Moreover, as shown in FIG. 8, it is necessary to dispose the fuse to each terminal of the differential inputs, respectively, which becomes a factor that increases the area of the interface part.

One example that is a typical configuration of the present invention will be shown as follows. That is, the semiconductor integrated circuit device of the present invention has a protection object circuit that is equipped with a differential input pair and becomes an object of electrostatic protection relating to an electrostatic noise originating in at least either input of the differential input pair, and an electrostatic protection element for protecting the protection object circuit from the electrostatic noise, wherein the protection element is configured to be connected to a middle point of a terminator that connects together one and the other inputs of the differential input pair.

According to embodiments of the present invention, in the semiconductor integrated circuit device configured so that its power supply net or ESD (Electrostatic Discharge) protection element may be electrically connectable and separable, it becomes possible that a transferable frequency and waveform quality are maintained and an area of an interface part is reduced while ESD protection performance is maintained at a level that does not affect a circuit operation (operation at a few GHz to 10 GHz or more).

### BRIEF DESCRIPTION OF THE DRAWINGS

Exemplary embodiments of the present invention will be described in detail based on the following figures, in which:

FIG. 1 is a schematic diagram relating to a first embodiment of a semiconductor integrated circuit device of the present invention;

FIG. 2 is a schematic diagram relating to a second embodiment of the semiconductor integrated circuit device of the present invention;

FIG. 3 is a schematic diagram relating to a third embodiment of the semiconductor integrated circuit device of the present invention;

FIG. 4 is a schematic diagram relating to a fourth embodiment of the semiconductor integrated circuit device of the present invention;

FIG. 5 is a schematic diagram relating to a fifth embodiment of the semiconductor integrated circuit device of the present invention;

FIG. 6 is a schematic diagram relating to a sixth embodiment of the semiconductor integrated circuit device of the present invention;

FIG. 7 is a schematic diagram of the related art technology;

FIG. 8 is a schematic diagram of a case where the related art technology is applied to a differential input pair;

FIG. 9 is a diagram showing electric potential fluctuations of ideal differential inputs and an amplitude center;

FIG. 10 is a diagram showing the electric potential fluctuation of the amplitude center when a difference of a timing or level between the differential inputs arises;

FIG. 11 is a schematic diagram of a fuse relating to the present invention;

FIG. 12 is a circuit block diagram showing an example of a semiconductor integrated circuit chip of the present invention with a resistance built in the chip; and

FIG. 13 is a circuit block diagram showing an example of a configuration of the semiconductor integrated circuit chip of the present invention with a resistance externally connected to the chip.

### DETAILED DESCRIPTION OF THE PREFERRED EMBODIMENTS

The semiconductor integrated circuit device of the present invention is characterized in that an ESD protection element separable at the time of actual use is not disposed to every terminal of differential inputs but at a middle point of a terminator between the differential inputs. For example, the semiconductor integrated circuit device is configured so that an arbitrarily separable electrostatic protection element may exist at the middle point of the terminator of the differential inputs and a remaining node after fuse blowout may exist at the middle point of the terminator. Since the electrostatic protection element and a device to be protected are connected together through a resistance with a resistance value one half of that of the terminator, ESD protection performance falls compared with the case of being connected not through the resistance. However, in a situation where the ESD occurring at the time of manufacture is loosened by the progress of countermeasures against static electricity in production lines (for example, equal to or lower than 100 V), it is possible to make small an influence on the device caused by reduction of the above-mentioned ESD protection performance by designing taking them into consideration. Rather than this possibility, being located at the middle point of the terminator makes the remaining node become an amplitude center of the differential inputs, and consequently an advantage that the electric potential fluctuation becomes extremely smaller can be enjoyed.

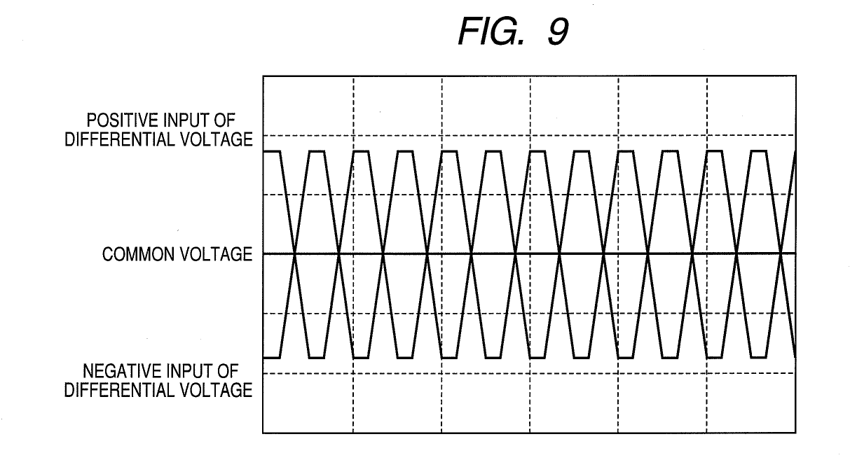

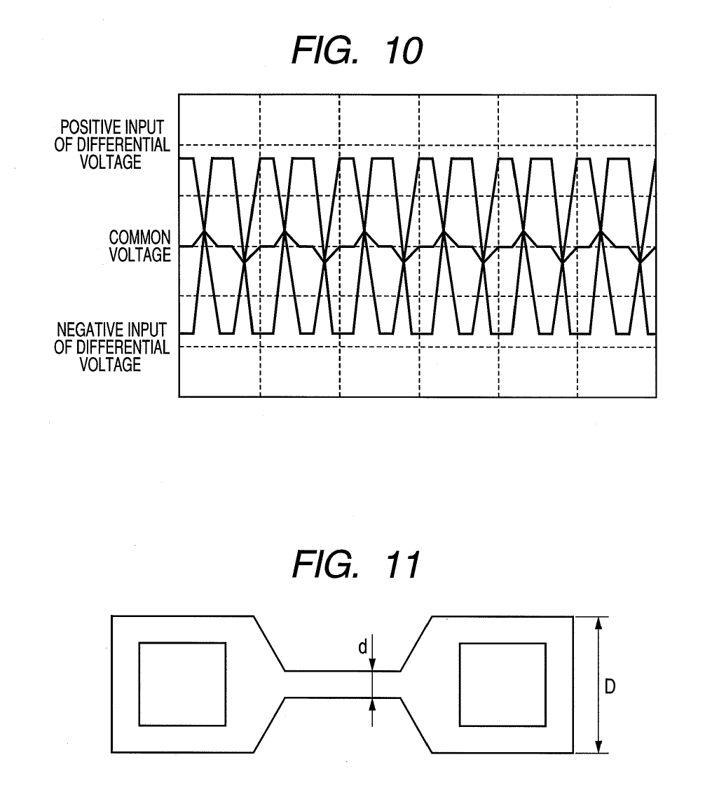

FIG. 9 states the electric potential fluctuations of ideal differential inputs and their amplitude center, and FIG. 10 states the electric potential fluctuations of actual differential inputs and their amplitude center, respectively. As shown in FIG. 9, the common voltage does not fluctuate in the case of the ideal differential inputs. However, it is expected that differences in timing and level may occur between the differential inputs practically, which will fluctuate the common voltage as shown in FIG. 10. Even in that case, the electric potential fluctuation of the node is suppressed to be small as shown in the figure. Therefore, a charging/discharging time of the remaining nodes become short, and maintenance of a transferable frequency band and input waveform quality is made possible.

Moreover, since protection object circuits pertaining to the respective two terminals, respectively, are protected in common by the single electrostatic protection element, the number of its disposition can be reduced by half compared with the case where the fuse is installed for every terminal. However, since it takes charge of the electrostatic protection for the two terminals, tolerance over blowout of the fuse must be as large as for the two terminals. However, as shown in FIG. 11, since the width of a blowout part of the fuse is sufficiently small relative to the width of the whole fuse element, even when the tolerance over blowout is maintained, an area occupied by the fuse is the same; therefore, area superiority can be acquired by reduction by half of the number of disposition of the fuse.

A marked feature of the present invention is that the separable electrostatic protection element is disposed at the middle point of the terminator. In the present invention, it is disposed so that the remaining node may remain at the common voltage at which the electric potential fluctuation is small at the time of operation. As described in the above-mentioned JP-A-2001-244338, JP-A-2007-073928, JP-A-He105 (1993)-121662, and JP-A-2004-128363, by the method of the related art technology whereby the separable electrostatic protection element is disposed to every terminal, the charging/discharging time increases at the time of electric potential fluctuation of an input signal due to the remaining node after the separation remaining at the both ends of the differential pair, which will obstruct a high speed operation. The present invention eliminates this point. Moreover, an increase quantity of the area by the fuse can be reduced by half compared with the case where the fuse is installed for every terminal.

Specifically, the semiconductor integrated circuit device of the present invention is equipped with the protection object circuit that has a differential input pair and becomes an object of the electrostatic protection relating to an electrostatic noise originating in at least either input of the differential input pair, and the electrostatic protection element for protecting the protection object circuit from the electrostatic noise. The protection element is configured to be connected to the middle point of the terminator that connects one and the other inputs of the differential input pair.

Here, it is suitable for the electrostatic protection element to be configured to be electrically separable. In that case, it is further suitable if the configuration of electrically separating the electrostatic protection element is a fuse that, for example, the electrostatic protection element and the middle point of the terminator are connected together and can be blown out with heat. It is further suitable if the fuse is at least either of a metal fuse or a silicon fuse. It is further suitable if the metal fuse is made to be constructed including, for example, aluminum wiring. It is further suitable if the silicon fuse is made to be constructed including, for example, an amorphous silicon film.

In the semiconductor integrated circuit device of the present invention, it is suitable if the electrostatic protection element is configured to include a first diode constructed so that its anode side is connected to the middle point of the terminator and a second diode constructed so that its cathode side is connected to the middle point of the same terminator. Also in that case, it is suitable that the electrostatic protection element is configured to be electrically separable, and further it is suitable that the configuration that makes the electrostatic protection element electrically separable is specified as a fuse, as is the case of other embodiments.

In the semiconductor integrated circuit device of the present invention, it may be equipped with differential input terminals to which the differential input pair is connected and into which the input signal is inputted from the outside. In that case, it is suitable if the terminator is made to be built in the semiconductor integrated circuit device together with the protection object circuit, the electrostatic protection element, and the differential input terminals. Also in that case, it is suitable that the electrostatic protection element is configured to be electrically separable, and further it is suitable that the configuration that makes the electrostatic protection element electrically separable is specified as a fuse, as is the case of other embodiments.

Moreover, the semiconductor integrated circuit device of the present invention may be configured to be further equipped with a center tap that is connected to the middle point of the terminator and from which a bias voltage for stabilizing the electric potential of the input signal is inputted. In that case, it is suitable if the center tap is made to be built in the semiconductor integrated circuit device together with the protection object circuit, the electrostatic protection element, the differential input terminals, and the terminator. Even in that case, it is suitable that the electrostatic protection element is configured to be electrically separable, and further it is suitable that the configuration that makes the electrostatic protection element electrically separable is specified as a fuse, as is the case of other embodiments.

Moreover, the semiconductor integrated circuit device of the present invention may be configured so that the terminator may be externally connected to the semiconductor integrated circuit device. In that case, it is suitable that the semiconductor integrated circuit device further comprises differential input terminals to which the differential input pair is connected and into which the input signal is inputted from the outside, and the center tap connected to the electrostatic protection element, and it is configured so that the middle point of the terminator may be connected to the electrostatic protection element through the center tap. Moreover, it is suitable for the differential input terminals to be built in the semiconductor integrated circuit device together with the electrostatic protection element that is connected to the protection object circuit and the center tap. Even in that case, it is suitable that the electrostatic protection element is configured to be electrically separable, and it is further suitable that the configuration that makes the electrostatic protection element electrically separable is specified as a fuse, as is the case of other embodiments.

Hereafter, embodiments of the present invention will be described in detail using drawings.

### First Embodiment

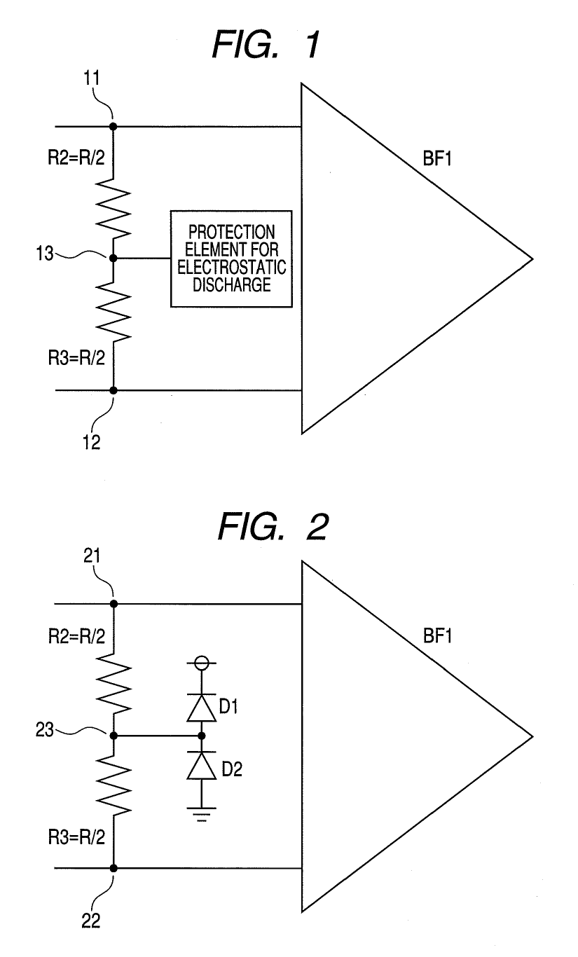

FIG. 1 is a schematic diagram of a first embodiment of a semiconductor integrated circuit device of the present invention. Differential input terminals 11 and 12 of a differential input buffer BF1 are connected to each other by a terminator R consisting of a series connection of resistances R2 and R3, and the electrostatic protection element is connected to a junction point of the resistances R2 and R3, namely, an intermediate node 13 of the terminator R. The differential input buffer BF1, the differential input terminals 11, 12, the resistances R2, R3, the intermediate node 13, and the electrostatic protection element are monolithically formed on a common semiconductor substrate, and constitute the semiconductor integrated circuit device. The electrostatic protection element is provided in order to prevent a malfunction from arising in the differential input buffer BF1 by electrostatic noises originating in the differential terminals 11, 12, for example, when attaching the semiconductor integrated circuit device to a circuit board or other occasions, and is configured so that the electrostatic noises originating in the differential terminals 11, 12 may flow into the electrostatic protection element through the resistances R2, R3, respectively. Here, the resistances R2 and R3 are equal to each other in resistance value, and each resistance value is one half of the resistance value of the terminator R, the intermediate node 13 of the terminator R corresponding to the middle point of the terminator R. In this embodiment, by the electrostatic protection element being disposed at a middle point 13 of the terminator R between the differential terminals 11, 12, the single electrostatic protection element provides commonly the electrostatic protection to the protection object circuits pertaining to the respective differential terminals 11, 12.

When the semiconductor integrated circuit device performs an actual operation after being implemented on the circuit board etc., the electrostatic protection element is seen as an input load. However, due to the electrostatic protection element being connected to the middle point 13 of the terminator R that corresponds to the common voltage, the load is effectively seen smaller and deteriorating the input waveform quality is substantially suppressed.

According to this embodiment, the middle point of the terminator corresponds to the common voltage at which the electric potential fluctuation at the time of actual operation is small, so that it is possible to shorten the charging/discharging time of the electrostatic protection element that gives a large input load; therefore, there can be produced a special effect that the maintenance and improvement of the transferable frequency band and the input waveform quality become possible.

### Second Embodiment

FIG. 2 is a schematic diagram of a second embodiment of the semiconductor integrated circuit device of the present invention. This embodiment is an example of the first embodiment in which diodes are used as the electrostatic protection element therein. Differential input terminals 21 and 22 of the differential input buffer BF1 are connected with each other by the terminator R consisting of a series connection of the resistances R2 and R3, and an anode side of a diode D1 and a cathode side of a diode D2 are commonly connected to the junction point of the resistances R2 and R3, namely, an intermediate node 23 of the terminator R. The two diodes D1, D2 function as the electrostatic protection element by being commonly connected to the intermediate node 23. The differential input buffer BF1, the differential input terminals 21, 22, the resistances R2, R3, the intermediate node 23 and the diodes D1, D2 are monolithically formed on a common semiconductor substrate, and constitute the semiconductor integrated circuit device. The electrostatic protection element consisting of the two diodes D1, D2 is provided in order to prevent a malfunction from arising in the differential input buffer BF1 by electrostatic noises originating in the differential terminals 21, 22, for example, when attaching the semiconductor integrated circuit device to the circuit board, and is configured so that the electrostatic noises originating in the differential terminals 21, 22 flow into either of the two diodes D1, D2 through the resistances R2, R3, respectively. Here, the resistances R2 and R3 are equal to each other in resistance value, and each resistance value is one half of the resistance value of the terminator R, the intermediate node 23 of the terminator R corresponding to the middle point of the terminator R. In this embodiment, by disposing the electrostatic protection element consisting of the diodes D1, D2 at the middle point 23 of the terminator R between the differential terminals 21, 22, the single protection element consisting of the pair of diodes provides commonly the electrostatic protection to the protection object circuits pertaining to the respective differential terminals 21, 22.

When the semiconductor integrated circuit device performs an actual operation after being implemented on the circuit board etc., the diodes D1, D2 are seen as the input load. However, since the diodes D1, D2 are connected to the middle point 23 of the terminator R that corresponds to the common voltage, the load is effectively seen smaller, and deteriorating the input waveform quality is substantially suppressed.

According to this embodiment, it is possible to shorten the charging/discharging time at the time of actual operation of the electrostatic protection element, similarly with the first embodiment, and because it is of a very simple configuration, there can be produced a special effect that erroneous operations are less compared with the case of the electrostatic protection element in which several elements are combined (a shunt circuit etc.).

### Third Embodiment

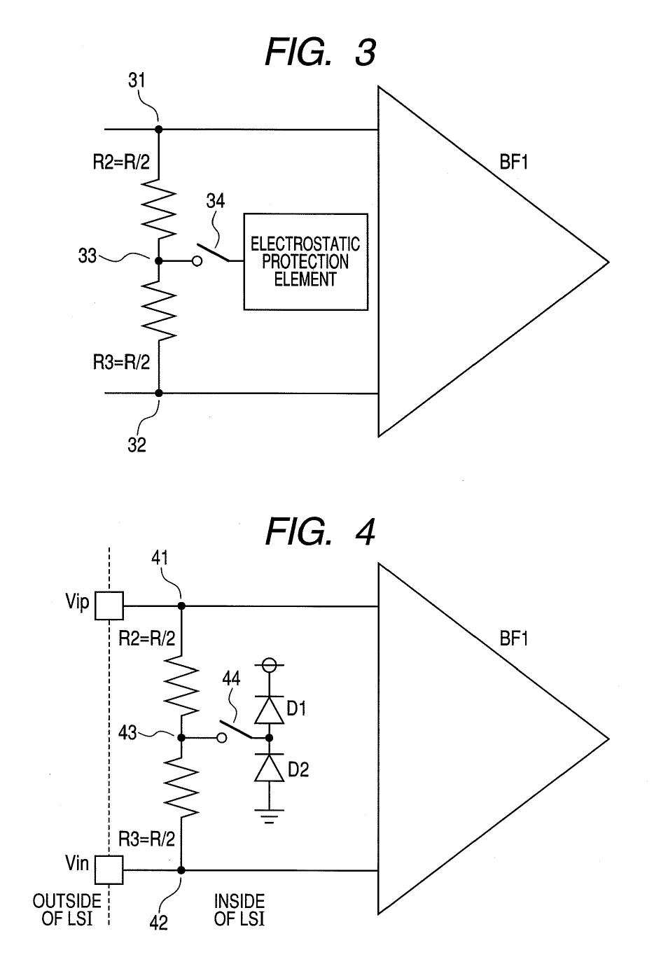

FIG. 3 is a schematic diagram of a third embodiment of the semiconductor integrated circuit device of the present invention. This embodiment is an embodiment having a configuration capable of separating the electrostatic protection element that gives the large input load at the time of actual operation in order to attain further speed enhancement from the first embodiment. Differential input terminals 31 and 32 of the differential input buffer BF1 are connected to each other by the terminator R consisting of the series connection of the resistances R2 and R3, and the electrostatic protection element is connected to the junction point of the resistances R2 and R3, namely, an intermediate node 33 of the terminator R through a switch 34. The differential input buffer BF1, the differential input terminals 31, 32, the resistances R2, R3, the intermediate node 33, the switch 34, and the electrostatic protection element are monolithically formed on a common semiconductor substrate, and constitute the semiconductor integrated circuit device. The electrostatic protection element is provided in order to prevent a malfunction from arising in the differential input buffer BF1 by the electrostatic noises originating in differential terminals 31, 32, for example, when attaching the semiconductor integrated circuit device to the circuit board, and is configured so that the electrostatic noises originating in the differential terminals 31, 32 may flow into the electrostatic protection element through the resistances R2, R3 and the switch 34, respectively. Here, the resistances R2 and R3 are equal to each other in resistance value, and each resistance value is one half of the resistance value of the terminator R, the intermediate node 33 of the terminator R corresponding to the middle point of the terminator R. In this embodiment, by disposing the electrostatic protection element at the middle point of the terminator R between the differential terminals 31, 32 through the switch 34, similarly with the above-mentioned first embodiment, the single protection element provides commonly the electrostatic protection to the protection object circuits pertaining to the respective differential terminals 31, 32.

When the semiconductor integrated circuit device performs an actual operation after being implemented on the circuit board etc., the electrostatic protection element is seen as the input load. However, by the electrostatic protection element being separated by the switch 34 at the time of actual operation, the load reduces to only the remaining node after the separation, and the input load becomes relatively small. Furthermore, by a fact that the remaining node is also connected to a middle point 33 of the terminator R that corresponds to the common voltage at which the electric potential fluctuation at the time of actual operation is small, the load being seen by the remaining node is also effectively seen further smaller, so that it is possible to shorten the charging/discharging time; therefore, deteriorating the input waveform quality is substantially suppressed.

According to this embodiment, there can be produced a special effect that enables speed enhancement by separation of the electrostatic protection element that gives the large input load and shortening of the charging/discharging time due to the remaining node after the separation being located at the common voltage at which the electric potential fluctuation is small. Moreover, since the protection object circuits pertaining to the respective two terminals are commonly protected, it is possible to reduce to a half the number of dispositions of the fuses that separate the electrostatic protection element, so that the area superiority is acquired.

### Fourth Embodiment

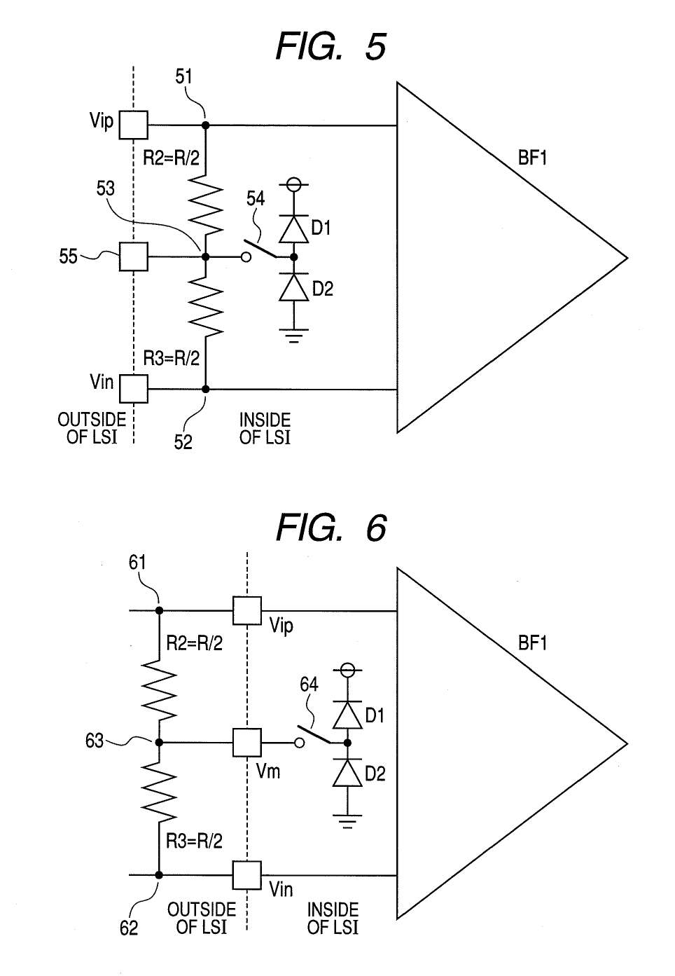

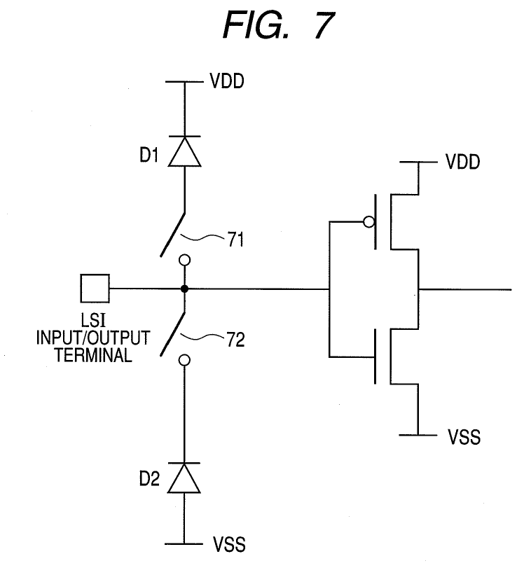

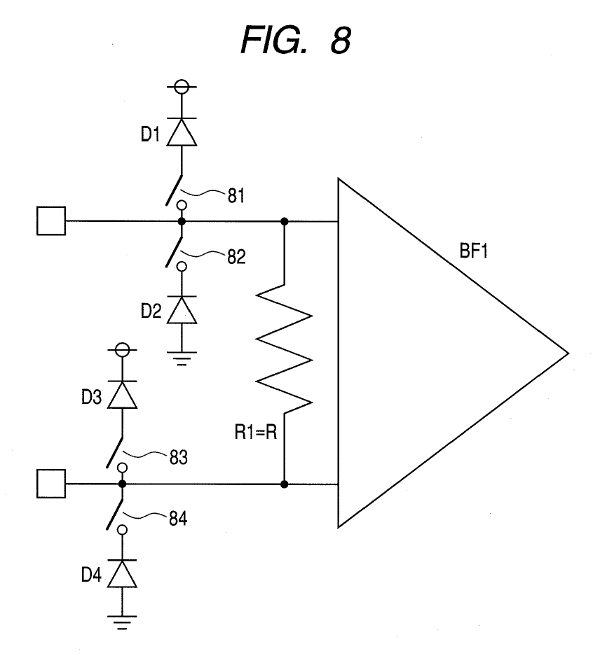

FIG. 4 is a schematic diagram of a fourth embodiment of the semiconductor integrated circuit device of the present invention. Differential input terminals 41 and 42 of the differential input buffer BF1 are connected to each other by the terminator R consisting of the series connection of the resistances R2 and R3, and the anode side of the diode D1 and the cathode side of the diode D2 are commonly connected to the junction point of the resistances R2 and R3, namely, the intermediate node 43 of the terminator R. The two diodes D1, D2 function as the electrostatic protection element by being commonly connected to the intermediate node 43. Inputs of the differential input pair Vip, Vin are connected to the resistances R2, R3, respectively. That is, one end of the resistance R2 is commonly connected to the resistance R3 and a switch 44, and the other end thereof is connected to Vip that is the one input of the differential input pair. Moreover, one end of the resistance R3 is commonly connected to the resistance R2 and the switch 44, and the other end thereof is connected to Vin that is the other input of the differential input pair. The differential input buffer BF1, the differential input terminals 41, 42, the resistances R2, R3, the intermediate node 43, the switch 44, the differential input pair Vip, Vin, and the diodes D1, D2 are monolithically formed on a common semiconductor substrate, and constitute the semiconductor integrated circuit device. In FIG. 4, a dashed line passing through the differential input pair Vip, Vin shows a border of the semiconductor integrated device, and a right-hand portion of the dashed line and a left-hand portion thereof show the inside of the semiconductor integrated circuit device and the outside of the semiconductor integrated circuit device, respectively. The electrostatic protection element consisting of the two diodes D1, D2 is provided in order to prevent a malfunction from arising in the differential input buffer BF1 by electrostatic noises originating in differential terminals 41, 42, for example, when attaching the semiconductor integrated circuit device to the circuit board, and is configured so that the electrostatic noises originating in the differential terminals 41, 42 flow into either of the two diodes D1, D2 through the resistances R2, R3 and the switch 44, respectively. Here, the resistances R2 and R3 are equal to each other in resistance value, and each resistance value is one half of the resistance value of the terminator R, the intermediate node 43 of the terminator R corresponding to the middle point of the terminator R. In this embodiment, by disposing the electrostatic protection element consisting of the diodes D1, D2 at the middle point 43 of the terminator R between the differential terminals 41, 42 through the switch 44, similarly with the above-mentioned second embodiment, the electrostatic protection element consisting of the pair of diodes provides commonly the electrostatic protection to the protection object circuits pertaining to the respective differential terminals 41, 42.

When the semiconductor integrated circuit device performs an actual operation after being implemented on the circuit board etc., the diodes D1, D2 are seen as the input load. However, by the diodes D1, D2 being separated by the switch 44 at the time of actual operation, the load reduces to only the remaining node after the separation, and the input load becomes relatively small. Here, although it is suitable to use the fuse for the switch 44, the present invention is not limited to it. In the case of adapting a configuration in which the diodes D1, D2 are connected to the intermediate node 43 through the fuse, what is necessary is just to make them function as the electrostatic protection element through the fuse at the time of assembly, and to reduce an input capacitance that becomes hindrance of an operation by cutting the fuse at the time of actual operation. Furthermore, by a fact that the remaining node after the fuse blowout is also connected to the middle point 43 of the terminator R that corresponds to the common voltage at which the electric potential fluctuation at the time of actual operation is small, the load being seen by the remaining node is also effectively seen further smaller, so that it is possible to shorten the charging/discharging time; therefore, deteriorating the input waveform quality is substantially suppressed.

According to this embodiment, together with the speed enhancement and the area superiority realized by the separation of the electrostatic protection element and by the shortening of the charging/discharging time, similarly with the above-mentioned third embodiment; there can be produced the special effect that less misoperations occur, similarly with the above-mentioned second embodiment.

### Fifth Embodiment

FIG. 5 is a schematic diagram of a fifth embodiment of the semiconductor integrated circuit device of the present invention. What is different from the fourth embodiment is that the center tap comes out to the outside of the apparatus from the intermediate node that is the middle point of the terminator. Differential input terminals 51 and 52 of the differential input buffer BF1 are connected to each other by the terminator R consisting of the series connection of the resistances R2 and R3, The anode side of the diode D1 and the cathode side of the diode D2 are commonly connected to the junction point of the resistances R2 and R3, namely, an intermediate node 53 of the terminator R through the switch 54, and a center tap 55 is connected thereto. The two diodes D1 and D2 function as the electrostatic protection element by being commonly connected to the intermediate node 53. Inputs of the differential input pair Vip, Vin are connected to the resistances R2, R3, respectively. That is, the one end of the resistance R2 is commonly connected to the resistance R3, the switch 54, and the center tap 55, and the other end thereof is connected to Vip that is the one input of the differential input pair. Moreover, the one end of the resistance R3 is commonly connected to the resistance R2, the switch 54, and the center tap 55, and the other end thereof is connected to Vip that is the other input of the differential input pair. The differential input buffer BF1, the differential input terminals 51, 52, the resistances R2, R3, the intermediate node 53, the switch 54, the differential input pair Vip, Vin, the center tap 55, and the diodes D1, D2 are monolithically formed on a common semiconductor substrate, and constitute the semiconductor integrated circuit device. In FIG. 5, a dashed line passing through the differential input pair Vip, Vin and the center tap 55 shows the border of the semiconductor integrated device, and a right-hand portion of the dashed line and a left-hand portion thereof show the inside of the semiconductor integrated circuit device and the outside of the semiconductor integrated circuit device, respectively. The electrostatic protection element consisting of the two diodes D1, D2 is provided in order to prevent a malfunction from arising in the differential input buffer BF1 by the electrostatic noises originating in the differential terminals 21, 22, for example, when attaching the semiconductor integrated circuit device to the circuit board, and is configured so that the electrostatic noises originating in the differential terminals 21, 22 flow into either of the two diodes D1, D2 through the resistances R2, R3 and the switch 54, respectively. Here, the resistances R2 and R3 are equal to each other in resistance value, and each resistance value is one half of the resistance value of the terminator R, the intermediate node 53 of the terminator R corresponding to the middle point of the terminator R. In this embodiment, by disposing the electrostatic protection element consisting of the diodes D1, D2 at the middle point 53 of the terminator R between the differential terminals 51, 52 through the switch 54, similarly with the above-mentioned second and fourth embodiments, the electrostatic protection element consisting of the pair of diodes provides commonly the electrostatic protection to the protection object circuits pertaining to the respective differential terminals 51, 52. Moreover, in the case of this embodiment, the electrostatic protection element provides the electrostatic protection for the differential input pair Vip, Vin and the center tap 55 commonly.

When the semiconductor integrated circuit device performs an actual operation after being implemented to the circuit board etc., the diodes D1, D2 are seen as the input load. However, by the diodes D1, D2 being separated by the switch 54 at the time of actual operation, its load reduces to only the remaining node after the separation, and the input load becomes relatively small. Here, although it is suitable that the fuse is used for the switch 54, the present invention is not limited to it. In the case of adapting a configuration in which the diodes D1, D2 are connected to the intermediate node 53 through the fuse, what is necessary is just to make the diodes function as the electrostatic protection element through the fuse at the time of assembly, and to cut the fuse at the time of actual operation to reduce the input capacitance that becomes hindrance of the operation. Moreover, when making the fuse blow out, an electric potential difference can easily be given to both ends of the fuse, and consequently the blowout with Joule's heat is easy. Furthermore, since the remaining node after the fuse blowout is connected to the middle point 53 of the terminator R that corresponds to the common voltage at which the electric potential fluctuation at the time of actual operation is small, the load being seen by the remaining node is effectively seen further smaller, so that it is possible to shorten the charging/discharging time; therefore, deteriorating the input waveform quality is substantially suppressed.

According to this embodiment, in addition to the speed enhancement of signal transfer and the reduction of a chip area of the above-mentioned fourth embodiment, there can be produced a special effect that it becomes easy to perform fixation of the middle point electric potential of the differential signal and blowout of the fuse with Joule's heat.

### Sixth Embodiment

FIG. 6 is a schematic diagram of a sixth embodiment of the semiconductor integrated circuit device of the present invention. What is different from the forth embodiment is that the terminator is externally attached in this embodiment, and it has a configuration that, in the semiconductor apparatus side, has the differential input pair, the terminals for electrostatic protection that are independent from the input pair and protection element for electrostatic discharge that connects the terminals for electrostatic protection through the fuse. The differential input terminals 61 and 62 of the differential input buffer BF1 are connected to each other by the terminator R consisting of the series connection of the resistances R2 and R3, and the anode side of the diode D1 and the cathode side of the diode D2 are commonly connected to the junction point of the resistances R2 and R3, namely, an intermediate node 63 of the terminator R through a terminal Vm and a switch 64. By the two diodes D1, D2 being commonly connected to the intermediate node 63, they function as the electrostatic protection element. Inputs of the differential input pair Vip, Vin are connected to the resistances R2, R3, respectively. That is, one end of the resistance R2 is commonly connected to the resistance R3 and the terminal Vm, and the other end thereof is connected to Vip that is the one input of the differential input pair. Moreover, one end of the resistance R3 is commonly connected to the resistance R2 and the terminal Vm, and the other end thereof is connected to Vin that is the other input of the differential input pair. The differential input buffer BF1, the switch 64, the differential input pair Vip, Vin, the terminal Vm, and the diodes D1, D2 are monolithically formed on a common semiconductor substrate, and constitute the semiconductor integrated circuit device. On the other hand, the differential input terminals 61, 62, the resistances R2, R3, and the intermediate node 63 are externally attached to the semiconductor integrated circuit device from its outside. In FIG. 6, a dashed line passing through the differential input pair Vip, Vin and the terminal Vm shows the border of the semiconductor integrated device, and a right-hand portion of the dashed line and a left-hand portion thereof show the inside of the semiconductor integrated circuit device and the outside of the semiconductor integrated circuit device, respectively. The electrostatic protection element consisting of the two diodes D1, D2 is provided in order to prevent a malfunction from arising in the differential input buffer BF1 by the electrostatic noises originating in the differential terminals 41, 42, for example, when attaching the semiconductor integrated circuit device to the circuit board, and is configured so that the electrostatic noises originating in the differential terminals 61, 62 may flow into either of the two diodes D1, D2 through the resistances R2, R3, the terminal Vm, and the switch 64, respectively. Here, the resistances R2 and R3 are equal to each other in resistance value, and each resistance value is one half of the resistance value of the terminator R, the intermediate node 63 of the terminator R corresponding to the middle point of the terminator R. In this embodiment, by disposing the electrostatic protection element consisting of the diodes D1, D2 to the middle point 63 of the terminator R between the differential terminals 61, 62 through the terminal Vm and the switch 64, similarly with the above-mentioned second, fourth, and fifth embodiments, the electrostatic protection element consisting of the pair of the diodes provides commonly the electrostatic protection to the protection object circuits pertaining to the respective differential terminals 61, 62 with respect.

When the apparatus performs an actual operation after being implemented on the circuit board etc., the diodes D1, D2 are seen as the input load. However, by the diodes D1, D2 being separated by the switch 64 at the time of actual operation, the load is reduced to only the remaining node after the separation, so that the input load becomes relatively small. Here, although it is suitable to use the fuse for the switch 64, the present invention is not limited to it. In the case of adapting a configuration in which the diodes D1, D2 are connected to the intermediate node 63 through the terminal Vm and the fuse, what is necessary is just to make them function as the electrostatic protection element through the fuse at the time of assembly and to reduce the input capacitance that becomes hindrance of the operation by cutting the fuse at the time of actual operation. Furthermore, due to the remaining node after the fuse blowout being connected to the middle point 63 of the terminator R that corresponds to the common voltage at which the electric potential fluctuation at the time of actual operation is small through the terminal Vm, the load seen by the remaining node is effectively seen further smaller, so that it is possible to shorten the charging/discharging time; therefore, deteriorating the input waveform quality is substantially suppressed.

According to this embodiment, the resistance value of the terminal resistance can be easily altered, and also there can be produced a special effect that blowout of the fuse with Joule's heat becomes easy, similarly with the above-mentioned fifth embodiment, in addition to the speed enhancement of signal transfer and reduction of the chip area of the above-mentioned fourth embodiment.

### Seventh Embodiment

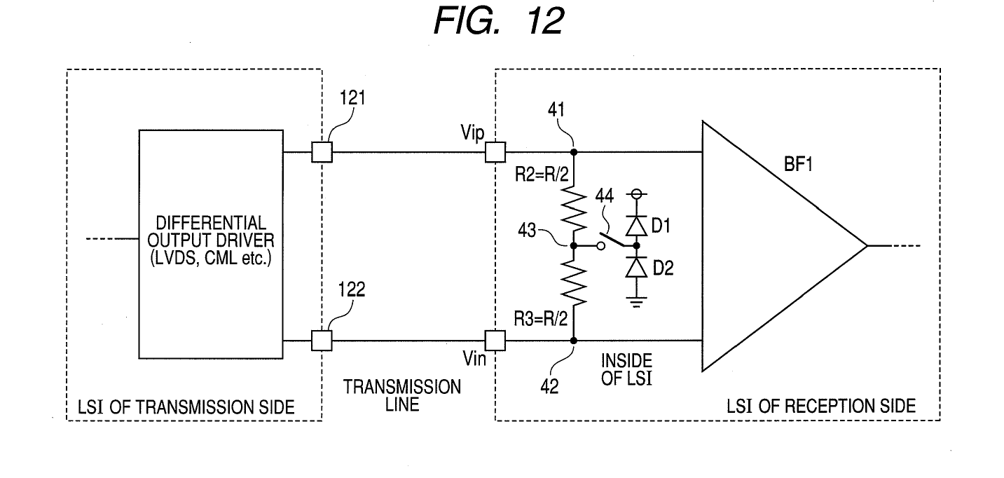

FIG. 12 is a schematic diagram of a seventh embodiment of the semiconductor integrated circuit device of the present invention. A receiving side LSI is a semiconductor integrated circuit device that has the same configuration as that of the above-mentioned fourth embodiment. A transmitting side LSI is a semiconductor integrated circuit device in which a differential output driver supporting a differential transmission system that is typified by LVDS (Low Voltage Differential Signaling), CML (Current Mode Logic), etc. and terminals (differential output pair) 121, 122 for outputting the differential output to the outside of the transmitting side LSI are monolithically formed on a common semiconductor substrate. These receiving side LSI and transmitting side LSI are connected with each other by a transmission line. Specifically, by the transmission line, Vip that is the one input of the differential input pair and the terminal 121 that is one output of the differential output pair are connected with each other, and Vin that is the other input of the differential input pair and the terminal 122 that is the other output of the differential output pair are connected with each other, which results in that the receiving side LSI and the transmitting side LSI are connected with each other in terms of a high frequency electric signal.

At the time of actual operations of the receiving side LSI and the transmitting side LSI, the differential output driver of the transmitting side LSI outputs a high frequency signal to the differential output pair 121, 122, and the high frequency signal is inputted into the differential input pair Vip, Vin through the transmission line and further is inputted into the differential input buffer BF1 after passing through the differential input terminals 41, 42. At this time, when the diodes D1, D2 are connected to the transmission line through the differential input pair Vip, Vin and the resistances R2, R3, the diodes D1, D2 are seen as the input load. However, by the diodes D1, D2 being separated by the switch 44, the load reduces to only the remaining node after the separation and the input load becomes relatively small. Here, that it is suitable to use the fuse for the switch 44 is the same as in the above-mentioned fourth embodiment. By a fact that the remaining node after the fuse blowout is connected to the middle point 43 of the terminator R that corresponds to the common voltage whose electric potential fluctuation at the time of actual operation is small, the load that is seen from the remaining node is effectively seen further smaller, so that it is possible to shorten the charging/discharging time; therefore, deteriorating the waveform quality is substantially suppressed.

According to this embodiment, even in the case where the semiconductor integrated circuit device of the present invention is used as the receiving side LSI to whose input side the transmitting side LSI having the differential output pair 121, 122 for outputting the high frequency signal is connected, an effect that less misoperations occur can be similarly acquired, together with the effects of the above-mentioned fourth embodiment, namely, the speed enhancement and the area superiority that are realized by the separation of the electrostatic protection element and by the shortening of the charging/discharging time of the remaining node after the separation.

### Eighth Embodiment

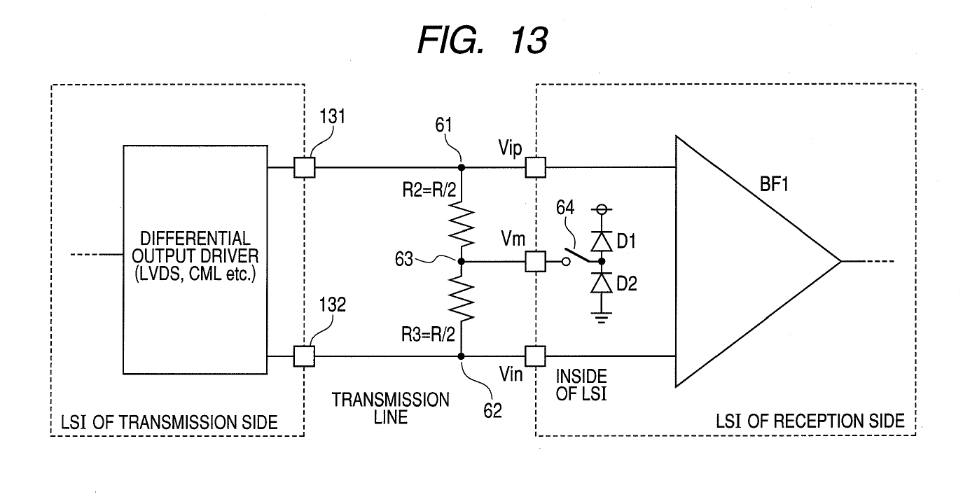

FIG. 13 is a schematic diagram of an eighth embodiment of the semiconductor integrated circuit device of the present invention. The receiving side LSI is a semiconductor integrated circuit device that has the same configuration as that of the above-mentioned sixth embodiment, and the terminator R consisting of the series connection of resistances R2 and R3 is externally connected to an input side thereof through the terminals Vip, Vin, and Vm. The transmitting side LSI is a semiconductor integrated circuit device in which the differential output driver supporting the differential transmission system that is typified by LVDS, CML, etc. and terminals (differential output pair) 131, 132 for outputting the differential output to the outside of the transmitting side LSI are the monolithically formed on a common semiconductor substrate, similarly with the above-mentioned the seventh embodiment. These receiving side LSI and transmitting side LSI are connected to each other by the transmission line. Specifically, by the transmission line, Vip that is the one input of the differential input pair or the terminal 61 that is one of the differential terminals and the terminal 131 that is one output of the differential output pair are connected with each other, and also Vin that is the other input of the differential input pair or the terminal 62 that is the other of the differential terminals and the terminal 132 that is the other output of the differential output pair are connected with each other, which results in that the receiving side LSI and the transmitting side LSI are connected to each other in terms of the high frequency electric signal.

At the time of actual operations of the receiving side LSI and the transmitting side LSI, the differential output driver of the transmitting side LSI outputs a high-frequency signal to the differential output pair 131, 132, and the high frequency signal is inputted into the differential input pair Vip, Vin through the transmission line and the differential input terminals 61, 62 and further is inputted into the differential input buffer BF1. At this time, when the diodes D1, D2 are connected to the transmission line through the resistances R2, R3, and the terminal Vm, the diodes D1, D2 are seen as the input load. However, by the diodes D1, D2 being separated by the switch 64, the load reduces to only the remaining node after the separation, and the input load becomes relatively small. Here, that it is suitable to use the fuse for the switch 64 is the same as in the above-mentioned sixth embodiment. By a fact that the remaining node after the fuse blowout is connected to the middle point 63 of the terminator R that corresponds to the common voltage whose electric potential fluctuation at the time of actual operation is small through the terminal Vm, the load that is seen by the remaining node is effectively seen further smaller, so that it is possible to shorten the charging/discharging time; therefore, deteriorating the input waveform quality is substantially suppressed.

According to this embodiment, also in the case where the semiconductor integrated circuit device of the present invention is used as the receiving side LSI to whose input side the transmitting side LSI having the differential output pair 131, 132 for outputting the high-frequency signal is connected, it is possible to acquire, similarly, the effect of the above-mentioned sixth embodiment, namely, an effect that the resistance value of the terminator can be easily altered, and also it becomes easy for the fuse to be blown out with Joule's heat, in addition to the speed enhancement of signal transfer and the reduction of the chip area.

In the foregoing, according to each of the above-mentioned embodiments of the present invention, the electrostatic protection element and the remaining node after the separation that are factors of an increase of the input capacitance will be located at the common voltage at which the electric potential fluctuation at the time of actual operation is small, which will shorten the charging/discharging time; therefore, it becomes possible to maintain the transferable frequency band and the waveform quality. Moreover, since the two terminals are protected simultaneously, it is possible to reduce the area that the fuse occupies to half compared with the case where the electrostatic protection element and the fuse are installed for every terminal.

Note that the embodiments described above are each one example of the suitable embodiment of the present invention, and implementation of various modifications is possible within a scope that does not deviate from the gist of the present invention.

What is claimed is:

1. A semiconductor integrated circuit device, comprising:
a protection object circuit that has a differential input pair and becomes an object of electrostatic protection relating to the electrostatic noise originating in at least either input of the differential input pair; and
an electrostatic protection element that protects the protection object circuit from the electrostatic noise,
wherein the protection element is configured to be connected to a middle point of a terminator that connects one and the other inputs of the differential input pair.

2. The semiconductor integrated circuit device according to claim 1,
wherein the electrostatic protection element is configured to be electrically separable.

3. The semiconductor integrated circuit device according to claim 2,
wherein the configuration that electrically separates the electrostatic protection element is a fuse that connects the electrostatic protection element with the middle point of the terminator and that is capable of being blown out with heat.

4. The semiconductor integrated circuit device according to claim 3,
wherein the fuse is at least either one of a metal fuse or a silicon fuse.

5. The semiconductor integrated circuit device according to claim 4,
wherein the metal fuse is constructed including aluminum wiring, and the silicon fuse is constructed including a polycrystalline silicon film.

6. The semiconductor integrated circuit device according to claim 1,
wherein the electrostatic protection element is configured including a first diode configured in such a manner that its anode side is connected to the middle point of the terminator and a second diode configured in such a manner that its cathode side is connected to the middle point of the terminator.

7. The semiconductor integrated circuit device according to claim 6,
wherein the electrostatic protection element is configured to be electrically separable.

8. The semiconductor integrated circuit device according to claim 7,
wherein the configuration that electrically separates the electrostatic protection element is a fuse that connects the electrostatic protection element with the middle point of the terminator and that is capable of being blown out with heat.

9. The semiconductor integrated circuit device according to claim 8,
wherein the fuse is at least either one of a metal fuse or a silicon fuse.

10. The semiconductor integrated circuit device according to claim 9,
wherein the metal fuse is constructed including aluminum wiring, and the silicon fuse is constructed including a polycrystalline silicon film.

11. The semiconductor integrated circuit device according to claim 6, further comprising:
differential input terminals to which the differential input pair is connected and into which input signals are inputted from the outside,
wherein the terminator is built in the semiconductor integrated circuit device together with the protection object circuit, the electrostatic protection element, and the differential input terminals.

12. The semiconductor integrated circuit device according to claim 11,
wherein the electrostatic protection element is configured to be electrically separable.

13. The semiconductor integrated circuit device according to claim 12,
wherein the configuration that electrically separates the electrostatic protection element is a fuse that connects the electrostatic protection element with the middle point of the terminator and that is capable of being blown out with heat.

14. The semiconductor integrated circuit device according to claim 11, further comprising:
a center tap that is connected to the middle point of the terminator and to which a bias voltage for stabilizing the electric potential of the input signal,
wherein the center tap is built in the semiconductor integrated circuit device together with the protection object circuit, the electrostatic protection element, the differential input terminals, and the terminator.

15. The semiconductor integrated circuit device according to claim 14,
wherein the electrostatic protection element is configured to be electrically separable.

16. The semiconductor integrated circuit device according to claim 15,
wherein the configuration that electrically separates the electrostatic protection element connects the electrostatic protection element with the middle point of the terminator and that is capable of being blown out with heat.

17. The semiconductor integrated circuit device according to claim 6, further comprising:
differential input terminals to which the differential input pair is connected and into which the input signal is inputted from the outside and a center tap that is connected to the electrostatic protection element,
wherein the differential input terminals and the center tap are built in the semiconductor integrated circuit device together with the protection object circuit and the electrostatic protection element,
wherein the terminator is configured in such a manner that the middle point of the terminator is connected to the electrostatic protection element through the center tap, and
wherein the terminator is arranged to be externally connected to the semiconductor integrated circuit device.

18. The semiconductor integrated circuit device according to claim 17,
wherein the electrostatic protection element is configured to be electrically separable.

19. The semiconductor integrated circuit device according to claim 18,
wherein the configuration that electrically separates the electrostatic protection element is a fuse that connects between the electrostatic protection element with the middle point of the terminator and that is capable of being blown out with heat.
